(19) United States
(12) Patent Application Publication
(10) Pub. No.: US 2013/0175804 A1
(43) Pub. Date: Jul. 11, 2013

(54) WIND TURBINE SHROUD AND WIND TURBINE SYSTEM USING THE SHROUD

(71) Applicant: Green Energy Technologies, LLC, Akron, OH (US)

(72) Inventors: Mark L. CIRONI, Fairlawn, OH (US); Nicholas C. MERLINI, III, Painesville, OH (US)

(73) Assignee: Green Energy Technologies, LLC, Akron, OH (US)

(21) Appl. No.: 13/777,360

(22) Filed: Feb. 26, 2013

Related U.S. Application Data
(63) Continuation-in-part of application No. 13/485,227, filed on May 31, 2012.
Application No. 13/485,227 is a continuation-in-part of application No. 13/431,206, filed on Mar. 27, 2012.
Application No. 13/431,206 is a continuation of application No. 11/845,094, filed on Aug. 27, 2007, now Pat. No. 8,257,019.
(60) Provisional application No. 60/871,135, filed on Dec. 21, 2006.

(51) Int. Cl. F03D 1/04

(52) U.S. Cl. CPC F03D 1/04
USPC 290/55; 415/220

(57) ABSTRACT

An annular shroud and a wind energy system including the annular wind shroud surround the rotatable constant chord blades of a wind turbine for generating electricity. The wind shroud includes a cylindrical wind tunnel body and a circular structural support ring, wherein the cylindrical wind tunnel body is formed of a plurality of wind tunnel body sector members carried on the circular structural support ring. Each of the plurality of wind tunnel body sector members of the cylindrical wind tunnel body are substantially identically formed. In one form the cylindrical wind tunnel body includes an air horn member on an intake opening edge, a circular cylindrical member, a conical member having a substantially constantly increasing diameter in the wind flowing direction, and a skirt member expanding radially outwardly. In another embodiment, the a conical member smoothly expands in the wind flowing direction.

### CROSS-REFERENCE TO RELATED APPLICATIONS

This application is a continuation-in-part of U.S. patent application Ser. No. 13/485,227, filed May 31, 2012, which is a continuation-in-part of U.S. patent application Ser. No. 13/431,206, filed Mar. 27, 2012, which is a continuation of U.S. patent application Ser. No. 11/845,094, filed Aug. 27, 2007, which claims the benefit of priority to U.S. provisional application No. 60/871,135, filed Dec. 21, 2006, wherein the contents of all of these applications are incorporated in their entirety herein by reference.

### TECHNICAL FIELD

The embodiments herein generally relate to methods and apparatus for producing electric power from a moving fluid flow. The embodiments herein also relate in particular to methods and apparatus for producing electric power from wind energy using a shroud shaped to beneficially modify a wind flow to increase a power of the flow within the shroud relative to an electromechanical turbine generator. The embodiments herein further relate to shroud apparatus for use with associated wind turbines for producing electricity and to methods and apparatus for easily and quickly assembling the shrouds and for mounting the shroud in a fixed position relative to the associated wind turbine.

### BACKGROUND

Most electricity today is generated by burning fossil fuels and producing steam which is then used drive a steam turbine that, in turn, drives an electrical generator. Unfortunately, however, the world's supply of fossil fuels is large, but finite. Exhaustion of low-cost fossil fuels will have significant consequences for energy sources as well as for the manufacture of plastics and many other things.

More serious are concerns about the emissions that result from fossil fuel burning. Fossil fuels constitute a significant repository of carbon buried deep under the ground. Burning them results in the conversion of this carbon to carbon dioxide, which is then released into the atmosphere. This results in an increase in the Earth's levels of atmospheric carbon dioxide, which enhances the greenhouse effect and contributes to global warming. Depending upon the particular fossil fuel and the method of burning, other emissions may be produced as well. Ozone, SO2, NO2 and other gases are often released, as well as particulate matter. Sulfur and nitrogen oxides contribute to smog and acid rain. Fossil fuels, particularly coal, also contain dilute radioactive material, and burning them in very large quantities releases this material into the environment, leading to low but real levels of local and global radioactive contamination. Coal also contains traces of toxic heavy elements such as mercury, arsenic and others. Mercury vaporized in a power plant's boiler may stay suspended in the atmosphere and circulate around the world.

An alternative source of renewable energy, solar cells, also referred to as photovoltaic cells, use the photovoltaic effect of semiconductors to generate electricity directly from sunlight. Their use has been rather limited because of high manufacturing costs. Disadvantageously, the manufacturing process also consumes considerable fossil fuels, resulting in pollution. Additionally, refined silicon required for the semiconductors is in short supply, making solar cells relatively costly. Solar electricity currently tends to be more expensive than electricity generated by other sources. Furthermore, solar energy is not available at night, may be unavailable due to weather conditions, and may be compromised during winter months; therefore, a storage or complementary power system is required for most applications.

Moreover, solar energy is inefficient. Expensive solar cells made from single crystal silicon are currently limited to about 25% efficiency because they are most sensitive to infrared light, and radiation in this region of the electromagnetic spectrum is relatively low in energy. Polycrystalline solar cells are made by a casting process in which molten silicon is poured into a mold and allowed to cool, then sliced into wafers. This process results in cells that are significantly less expensive to produce than single crystal cells, but whose efficiency is limited to less than 20% due to internal resistance at the boundaries of the silicon crystals. Amorphous cells are made by depositing silicon onto a glass substrate from a reactive gas such as silane (SiH4). This type of solar cell can be applied as a thin film to low cost substrates such as glass or plastic. Thin film cells have a number of advantages, including easier deposition and assembly, the ability to be deposited on inexpensive substrates, the ease of mass production, and the high suitability to large applications. Since amorphous silicon cells have no crystal structure at all, their efficiencies are presently only about 10% due to significant internal energy losses.

Another attractive alternative source of renewable energy, wind power, produces electricity from the flow of air over the surface of the earth. Wind rotates a rotor mechanically coupled to an electric generator to produce electricity. Unlike solar cells, properly located wind turbines can generate the energy used in its construction within just months of operation. Greenhouse gas emissions and air pollution produced by construction of a wind turbine are small and declining. There are no emissions or pollution produced by operation of a wind turbine. Modern wind turbines are almost silent and rotate so slowly (in terms of revolutions per minute) that they are rarely a serious hazard to birds. Aesthetic, landscape and heritage issues may be a significant issue for certain wind farms. However, when appropriate planning procedures are followed, these risks are minimal and should be weighed against the need to address the threats posed by climate change and the opinions of the broader community.

Unfortunately, conventional wind turbines suffer several serious shortcomings. For example, they rely exclusively on ambient wind speed. Nothing is done to effectively accelerate the wind or the power quotient of the wind at the rotating blades using negative pressures in an area downstream of the blades and thereby attempt to improve efficiency of the turbine. Known prior art wind energy systems that include a shroud create little meaningful negative pressure regions in an area downstream of the blades.

Another shortcoming of conventional wind turbines is the required excessive blade size to drive a particular generator. As conventional wind turbines do little to effectively augment wind speed, power requirements are met by up-sizing the rotor. A large generator, of course, requires substantial power provided by a large rotor to turn. This approach ignores the relationship of wind speed to power, whereby an increased wind speed augments power output. Disadvantageously, a larger rotor increases manufacturing and construction costs, stresses on the support structure, wear and tear on bearings, and maintenance costs.

The example embodiments herein are directed to overcoming one or more of the problems and solving one or more of the needs as set forth above.

### SUMMARY OF THE EMBODIMENTS

To solve one or more of the problems set forth above, in an exemplary implementation of the invention a wind energy system is provided with a shroud for each turbine. The shroud is adapted to direct and accelerate wind relative to the turbine. In accordance with an embodiment, the shroud effectively accelerates the wind and increases the power quotient of the wind at the rotating blades of an associated wind turbine using negative pressures developed by the shroud structure in an area downstream of the blades thereby significantly improving efficiency of the associated turbine. In accordance with an embodiment, the shroud comprises plural sector members or portions carried on an annular support ring member, whereby each of the plural sector members may be individually assembled onto the support ring member for ease of construction and installation of the shroud apparatus at the wind power site.

In accordance with one example embodiment, a wind shroud is provided for use with an associated wind power generator including a wind turbine for generating electricity. The wind shroud includes a cylindrical wind tunnel body defining a central longitudinal axis therethrough, the wind tunnel body having an inlet configured to receive a wind flow into the wind tunnel body, an outlet configured to expel the wind flow out from the wind tunnel body, and a central side wall portion configured to communicate the wind flow from the inlet to the outlet in a wind flowing direction. In the example embodiment, the cylindrical wind tunnel body comprises an air horn member narrowing in the wind flowing direction, the air horn member being formed on an intake opening edge of the inlet of the wind tunnel body; a circular cylindrical member having a substantially constant diameter in the wind flowing direction and being disposed between the air horn member and the outlet; a conical member having a substantially constantly increasing diameter in the wind flowing direction and being disposed between the circular cylindrical member and the outlet; a skirt member expanding radially outwardly and being disposed between the circular conical member and the outlet, the skirt member defining a first radius R; and a radially outwardly extending collar-shaped brim member formed on an outside of an exhaust opening edge of the outlet of the wind tunnel body. During use of the wind shroud, the associated wind turbine is configured to be arranged adjacent to the inlet of the wind tunnel body whereby wind shroud creates desirable negative pressure regions in an area downstream of the blades.

In accordance with another example embodiment, a wind power generator is provided for generating electricity from a moving fluid flow such as a wind flow for example. The wind power generator includes a wind shroud and a wind turbine having rotatable blades disposed in the wind shroud for generating electricity. The wind shroud includes a cylindrical wind tunnel body defining a central longitudinal axis therethrough, the wind tunnel body having an inlet configured to receive a wind flow into the wind tunnel body, an outlet configured to expel the wind flow out from the wind tunnel body, and a central side wall portion configured to communicate the wind flow from the inlet to the outlet in a wind flowing direction. In the example embodiment, the cylindrical wind tunnel body comprises an air horn member narrowing in the wind flowing direction, the air horn member being formed on an intake opening edge of the inlet of the wind tunnel body; a circular cylindrical member having a substantially constant diameter in the wind flowing direction and being disposed between the air horn member and the outlet; a conical member having a substantially constantly increasing diameter in the wind flowing direction and being disposed between the circular cylindrical member and the outlet; a skirt member expanding radially outwardly and being disposed between the circular conical member and the outlet, the skirt member defining a first radius R; and a radially outwardly extending collar-shaped brim member formed on an outside of an exhaust opening edge of the outlet of the wind tunnel body.

### BRIEF DESCRIPTION OF THE DRAWINGS

The foregoing and other aspects, objects, features, benefits, and advantages of the embodiments herein will become better understood with reference to the following description, appended claims, and accompanying drawings, wherein:

FIG. 1 is a perspective view of a wind power generator including a wind turbine for generating electricity and a wind shroud in accordance with an embodiment;

FIG. 2 is a schematic diagram of an internal block configuration of the wind power generator according to an embodiment in which a wind turbine generates electric power;

FIG. 3 is an elevational front view of a wind shroud apparatus formed in accordance with an example embodiment;

FIG. 4 is a perspective view of a support ring member for carrying and supporting sector members of the wind shroud apparatus shown in FIG. 3;

FIG. 5 is a cross-sectional view of the support ring member of FIG. 4, taken along line 5-5 thereof;

FIG. 6a is an elevational view of a first representative wind tunnel body sector member comprising the wind shroud apparatus shown in FIG. 3;

FIG. 6b is an elevational view of a second representative wind tunnel body sector member comprising the wind shroud apparatus shown in FIG. 3;

FIG. 7a is a cross-sectional view of the representative wind tunnel body sector member of FIG. 6a, taken along line 7a-7a thereof;

FIG. 7b is a cross-sectional view of the representative wind tunnel body sector member of FIG. 6b, taken along line 7b-7b thereof;

FIG. 8a is an elevational view of the representative wind tunnel body sector member of FIG. 7a taken along line 8a-8a thereof;

FIG. 8b is an elevational view of the representative wind tunnel body sector member of FIG. 7b taken along line 8b-8b thereof;

FIG. 9a is an elevational side view of the wind shroud apparatus shown in FIG. 3 and formed in accordance with a first example embodiment;

FIG. 9b is an elevational side view of the wind shroud apparatus shown in FIG. 3 and formed in accordance with a second example embodiment;

FIG. 10a is an enlarged cross-sectional view of a portion of the wind shroud apparatus of FIG. 9a within the circle identified at 10a;

FIG. 10b is an enlarged cross-sectional view of a portion of the wind shroud apparatus of FIG. 9b within the circle identified at 10b;

FIG. 11 is a top elevational view of a constant cord blade member used in the wind power generator system of FIGS. 1-3, 10a, and 10b;

FIG. 11a is a front elevational view of the constant cord blade member of FIG. 11 used in the wind power generator system of FIGS. 1-3, 10a, and 10b;

FIG. 11b is a rear elevational view of the constant cord blade member of FIG. 11 used in the wind power generator system of FIGS. 1-3, 10a, and 10b;

FIG. 11c is an outer end elevational view of the constant cord blade member of FIG. 11 used in the wind power generator system of FIGS. 1-3, 10a, and 10b; and,

FIG. 11d is an inner end elevational view of the constant cord blade member of FIG. 11 used in the wind power generator system of FIGS. 1-3, 10a, and 10b.

### DETAILED DESCRIPTION OF THE EMBODIMENTS

Referring to the Figures, in which like parts are indicated with the same reference numerals, various views of exemplary wind turbine systems and assemblies and components thereof according to principles of the embodiments are shown. An exemplary wind turbine system according to principles herein includes a specialized wind shroud having an air horn, a circular cylindrical member, a conical member, a skirt member, and a brim member, in combination with a wind turbine having rotatable blades disposed in the wind shroud for generating electricity. In the example embodiments the exemplary wind turbine system may selectively include a tower construction, a yaw drive assembly, a rotor with rotor blades, a nacelle with a drive train and miscellaneous other components.

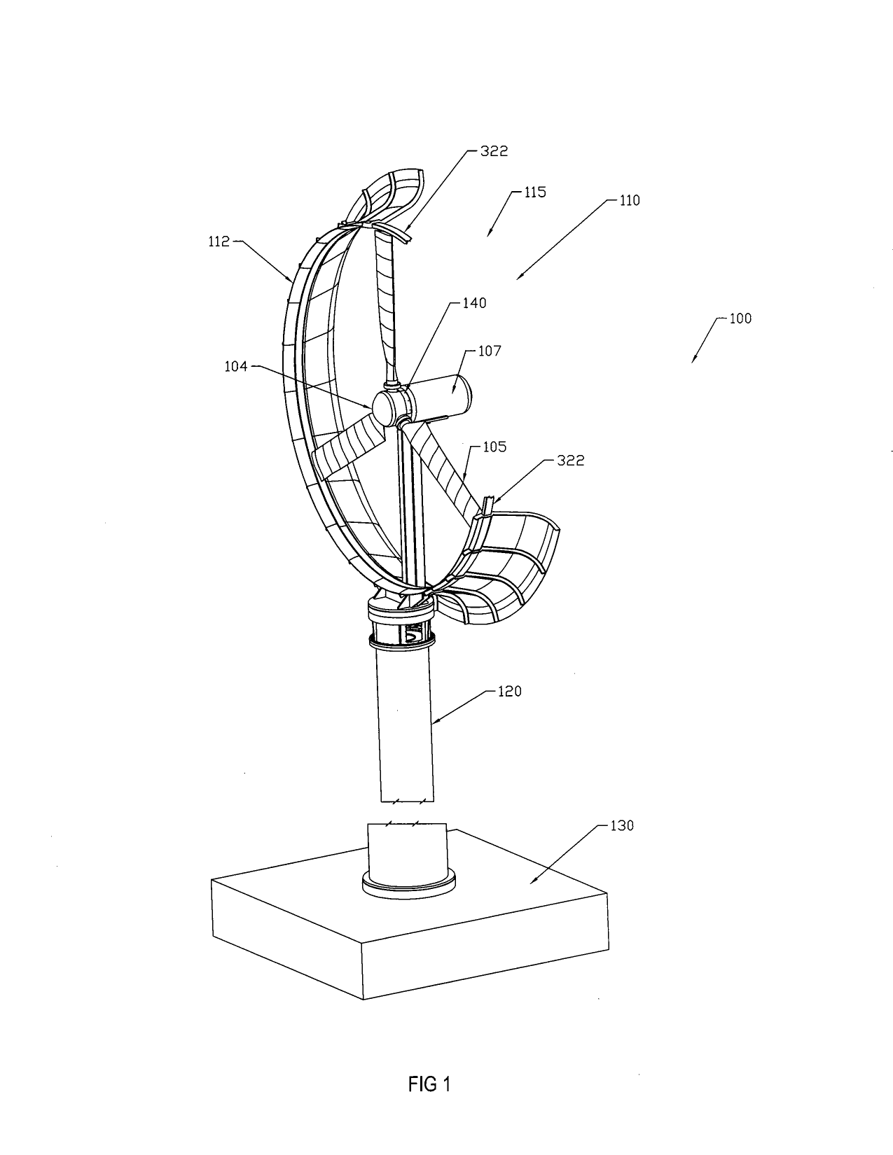

With reference first to FIG. 1, a wind tower system 100 includes a wind power generator 110 supported by a vertical support structure 120, and a foundation 130 which anchors the system 100 to the ground or to another support structure. In the example embodiment, the wind power generator 110 includes an annular wind shroud 112 and a wind turbine 104 for generating electricity. In order to ensure stability, one or more piles and/or a flat foundation may be used, depending on the consistency of the underlying ground. A flat foundation 130 comprises a large reinforced concrete slab which forms the footing of the generator. In a pile foundation, foundation plates (plate foundations) are fixed with piles into the earth. This is particularly useful in soft subsoil.

A tower construction, exemplary embodiments of which are described below, carries the weight of the supported equipment, including the wind shroud 112 and the wind turbine 104 and other components such as a support frame, nacelle, and the rotor blades 105 and generator 107 of the wind turbine, while withstanding the huge static loads caused by the varying power of the wind. The tower construction elevates the system to a desired height, e.g., thirty feet or more above ground level. A tower construction of concrete, steel or other building materials may be used. The tower construction may be a containment structure suitable for housing equipment, a lattice or truss assembly, or other suitable stable form. In the case of concrete, the tower may be constructed on site, which simplifies transport and fitting. Alternatively, pre-cast concrete segments may be shipped and assembled on site.

The wind power generator 110 supported by the vertical support structure 120 adapted for controlled yaw movement relative to the foundation 130 according to principles of the embodiments herein as shown. The support structure 120 may be mounted on a turntable of a yaw drive assembly controllably driven by a motor in accordance with U.S. Ser. No. 11/845,094 incorporated herein by reference. A nacelle 115 and rotor assembly, which comprises a hub 140 and plurality (e.g., three or more) of rotor blades 105, are supported by a frame (not shown for clarity of illustrating the shroud 112). The yaw motor may be manually actuated by a switch and/or automatically operated using a programmable logic controller, microcontroller or other control means, to maintain in a direction facing the wind.

In the example embodiment shown, the support structure 120 is essentially a mast, but may take on any desired configuration such as for example, a framework of beams forming a rigid A-shaped support structure. However, any structure suitable for supporting the wind shroud, nacelle and rotor assembly may be utilized and comes within the scope of the embodiments. Such structures may, for example, include tubular steel, concrete post, lattice structures, and other suitable structures.

The rotor assembly, with the help of the rotor blades 105, converts the energy in the wind into rotary mechanical movement. In an exemplary implementation, a three-blade, horizontal axis rotor assembly is utilized. The rotor blades 105 may be comprised of fiber reinforced (e.g., glass, aramid or carbon-fiber reinforced) plastics (GRP, CFRP), aluminum, alloys, combinations thereof, or other suitable material. The blade profile (airfoil shape) is similar to that of an aircraft wing and uses the same aerodynamic principles to generate lift, which cause the rotor to rotate. In the example embodiment, the blades 105 are constant chord blades having an MS 1-0317 foil configuration. Blades of this configuration have been found to work particularly well with the shroud member 112 shown in the Figure and described below. It is to be appreciated that other blade configurations may be used as necessary or desired.

The rotor comprises multiple rotor blades 105 attached to a hub 140. The rotor converts the wind energy into a rotation. In an exemplary embodiment, the rotor has three blades, a horizontal axis, and a diameter of approximately twenty-six (26) feet or more. The use of three (3) rotor blades 105 allows for a better distribution of mass than conventional two (2) blade designs, which makes rotation smoother. As an alternative, a five (5) blade design may be used as well and also allows a smaller diameter than conventional two (2) blade designs that produce similar forces under similar wind conditions.

The hub 140 is the center of the rotor assembly to which the rotor blades 105 are attached. The hub 140 directs the energy from the rotor blades 105 on to the generator 107. If the wind turbine has a gearbox, the hub 140 is connected to the gearbox shaft, converting the energy from the wind into rotation energy. If the turbine has a direct drive, the hub 140 passes the energy directly to a ring generator. Each rotor blade 105 can be attached to the hub 140 in various ways: either in a fixed position or with pitch adjustment. A fixed hub 140 is sturdy, reduces the number of movable components that can fail, and is relatively easy to construct. Pitch adjustment enables manual or remote adjustment of blade pitch to improve efficiency.

The hub 140 thus locates and captures the rotor blades 105 within a plane defined by the annular wind shroud 112. The hub 140 correctly positions the rotor blades 105 for correct tilt and angular placement. The blades selectively are locked in position using heavy duty mechanical clamps and a locking pin. The locking pin uses two hardened pins locating in a recess in the rotor blade and further locating in the hub 140 to provide positive locking. The blades can be manually adjusted for pitch in the hub 140.

In a preferred example embodiment, each individual rotor blade 105 can be infinitely adjusted manually, electromechanically or hydraulically, by turning into or out of the wind. In such an embodiment, the rotor blades may be positioned at a pitch angle suitable for generating acceptable lift, such as maximum lift, at a design wind speed (e.g., average prevailing local wind speed for the location of the turbine).

Alternatively, each individual rotor blade 105 can be adjusted automatically. Actuators for automated or remote pitch adjustment may be either hydraulic or electro-mechanical. In an automated embodiment, a controller monitors the turbine's power output and/or rotational speed. If the wind is too strong, the rotor blades 105 may be pitched slightly to reduce lift, so that the rotor continues to generate power at rated capacity even at high wind speeds. Otherwise, the system may maintain the rotor blades at a pitch angle suitable for generating acceptable lift, such as maximum lift, for the design or detected wind speed.

In a preferred example embodiment, each individual rotor blade 105 of a constant chord construction and has, preferably a MS 1-0317 foil contour or the like. Each of the plurality of blade members comprises an elongate wide constant cord body member. However, it is to be appreciated that the blades are not limited to the MS 1-0317 foil contour or to any other particular contour.

Contrary to current belief and trends towards tapered blades with slender profiles and more bulbous shaped foils primarily designed to reduce drag and maximize air flow through the blade disk, it has been found that highly desirable and unexpected beneficial results are achieved through use of constant chord blades when operating in the ducted environment such as, for example, as provided by the wind shroud apparatus 112 of the present embodiments. Constant chord blades in combination with the wind shroud apparatus 112 of the present embodiments provide vast power increases that are not achievable with the conventional tapered-style blade profile. It is believed that constant chord blades perform better in combination with the wind shroud apparatus 112 of the present embodiments due to the increased forces from the duct of the shroud capturing and/or restricting air pressure and/or flow that would normally be lost to an open bladed system. This captured air flow reacts directly on the last ⅓ of the blade adjacent the distal end or tip in several forms. However, it is believed that the most significant contribution is the increased pressure on the blades owing to the forces of the moving air as created by the shroud apparatus 112. In the example embodiments, due to the wide chord, manufacturing methods are used to address the weight and loads concerns wherein, in the example embodiment, most weight is preferably concentrated in the first ⅓ of the blade closest to the hub portion 140 of the wind turbine apparatus.

Advantageously, a wind turbine system according to principles of the example embodiments herein may utilize conventional commercially available electronic equipment, including a generator, a system for grid in-feed of the electricity, and various sensors and controls. The system for feeding electricity into the grid depends upon the generator used. In a variable speed turbine embodiment with a synchronous generator, alternating current generated fluctuates constantly in frequency and quantity. In order for the electricity to be fed into the grid, it is converted into direct current using a rectifier, filtered and then converted back into alternating current using an inverter. Voltage is converted for connection to the level of the grid using a transformer. Sensors for monitoring and control may be provided on and in the nacelle to measure wind speed and wind direction, speed of the rotors and the generator, the ambient temperature and temperature of individual components, oil pressure, pitch and azimuth angle (yaw mechanism based on the wind direction) and electrical values, as well as vibrations or vibrations in the nacelle. Data from sensor signals may be used to control operation. For example, in response to signals corresponding to wind direction, the yaw mechanism may be activated. An exemplary wind turbine system according to principles of the embodiments may also contain components lighting, cooling, heating, lightning protection, lifting gear (e.g. winches for spare parts), communications equipment and fire extinguishing equipment.

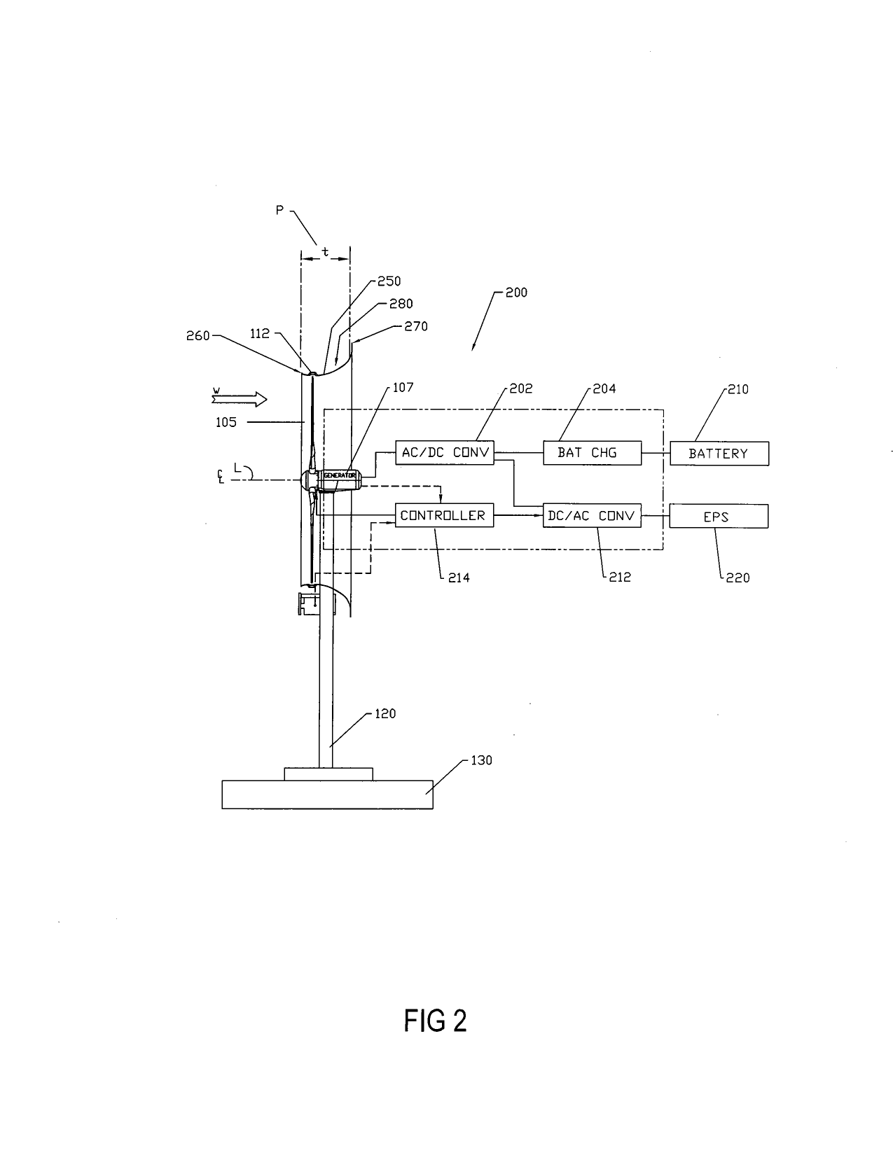

The electric power generating system 200 component of the system 100 of FIG. 1 is shown in schematic form in FIG. 2 and, with reference now to that Figure, the rotational force developed in the impeller blades 105 of the wind turbine by wind passing therethrough is transmitted to the electric generator 107 thereby driving the electric generator 107 and causing it to generate electric power. Electricity thereby generated may be supplied to an associated outside circuit such as for example the electric power grid or, preferably, to an electric storage device such as a battery 210. The wind turbine is not limited to a wind turbine equipped with an electric generator, however, wherein the rotational force may also be directly mechanically outputted without connection with the electric generator 107. For instance, the rotary shaft may be operatively coupled to a drive shaft of a pump for pumping water or the like.

In the example embodiment of use of the system 100 for generating electricity, the electric generator 107 generates AC power which is in turn supplied to an AC/DC converter 202, where the power is converted into DC power. The battery 210 is charged with the thus-converted DC power by means of a battery charger 204. The battery 210 can be utilized as an emergency power source. The DC power from the AC/DC converter 202 is subjected to power control performed by a DC/AC converter (inverter) 212, to thus again become predetermined power and converted into AC power. The AC power is sent as the AC power source to a power system 220. The above-described configuration of the power system 200 is presented by way of example only and is not intended to limit the embodiments herein. Other embodiments for example include those described in co-pending related application Ser. No. 11/845,094.

A voltage/current guided from the AC/DC converter 202 to the DC/AC converter 212 is detected as a voltage/current by means of a voltage/current sensor (not shown). A detection signal is input to the controller 214. In accordance with the detection signal, the controller 214 controls the DC/AC converter 212, thereby performing operation so as to keep the voltage constant and unchanged. The thus-controlled power is supplied to the associated power system 220.

With continued reference to FIG. 2, as illustrated in cross-section, the wind shroud 112 has a thickness t in a wind flowing direction W. As described above and as will be appreciated, the wind shroud 112 has an annular conformation and, accordingly, defines a plane P having the thickness t as illustrated. Preferably, the blades 105 of the generator are disposed within the thickness of the plane P for beneficial results of enhanced wind power concentration owing to the configuration of the shroud structure as will be described in greater detail below. In general, the wind shroud 112 includes a cylindrical wind tunnel body 250 defining a central longitudinal axis L therethrough. The wind tunnel body 250 has an inlet 260 configured to receive a wind flow into the wind tunnel body 250, an outlet 270 configured to expel the wind flow out from the wind tunnel body 250, and a central side wall portion 280 configured to communicate the wind flow from the inlet 260 to the outlet 270 in a wind flowing direction W.

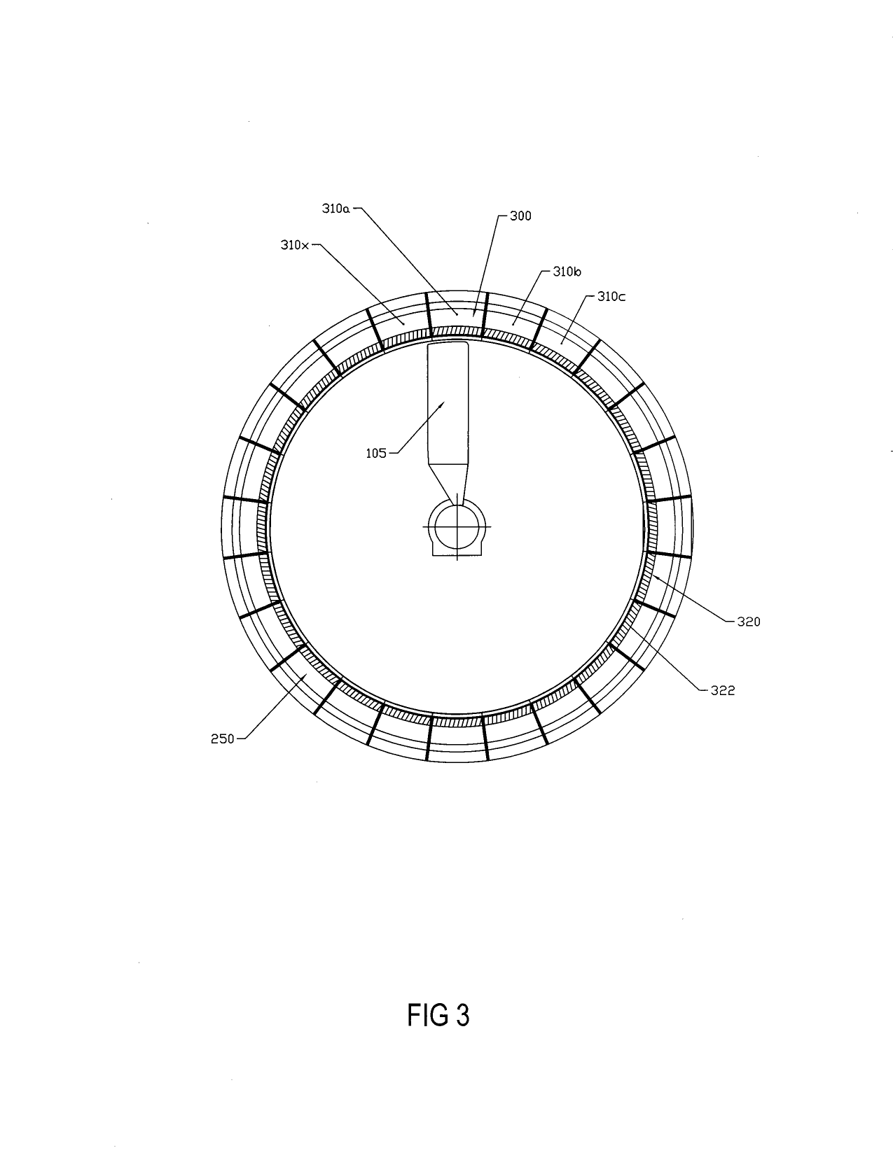

The preferred structure and overall configuration of the wind shroud 112 of the example embodiment is best understood with reference to FIGS. 3-10b wherein, as illustrated in FIG. 3, the wind shroud 112 has an annular overall shape. The cylindrical wind tunnel body 250 defines a central longitudinal axis L therethrough, and has an inlet 260 configured to receive a wind flow into the wind tunnel body, an outlet 270 configured to expel the wind flow out from the wind tunnel body, and a central side wall portion 280 configured to communicate the wind flow from the inlet to the outlet in a wind flowing direction W.

As shown in FIG. 3, the wind tunnel body 250 of the wind shroud 112 comprises a plurality of wind tunnel body sector members 300 including, in the example embodiment a set of twenty four (24) individual wind tunnel body sector members 310a-310x. As shown, a support member 320 is provided for carrying and supporting the plurality of wind tunnel body sector members 300 in the desired pattern shown. Preferably, the support member 320 is a circular support ring 322 made of metal such as, for example, steel, aluminum, or the like. It is further to be appreciated that, in the example embodiment illustrated, each of the wind tunnel body sector members 310a-310x subtends an angle about the annular overall shape the wind shroud 112 of about 15°.

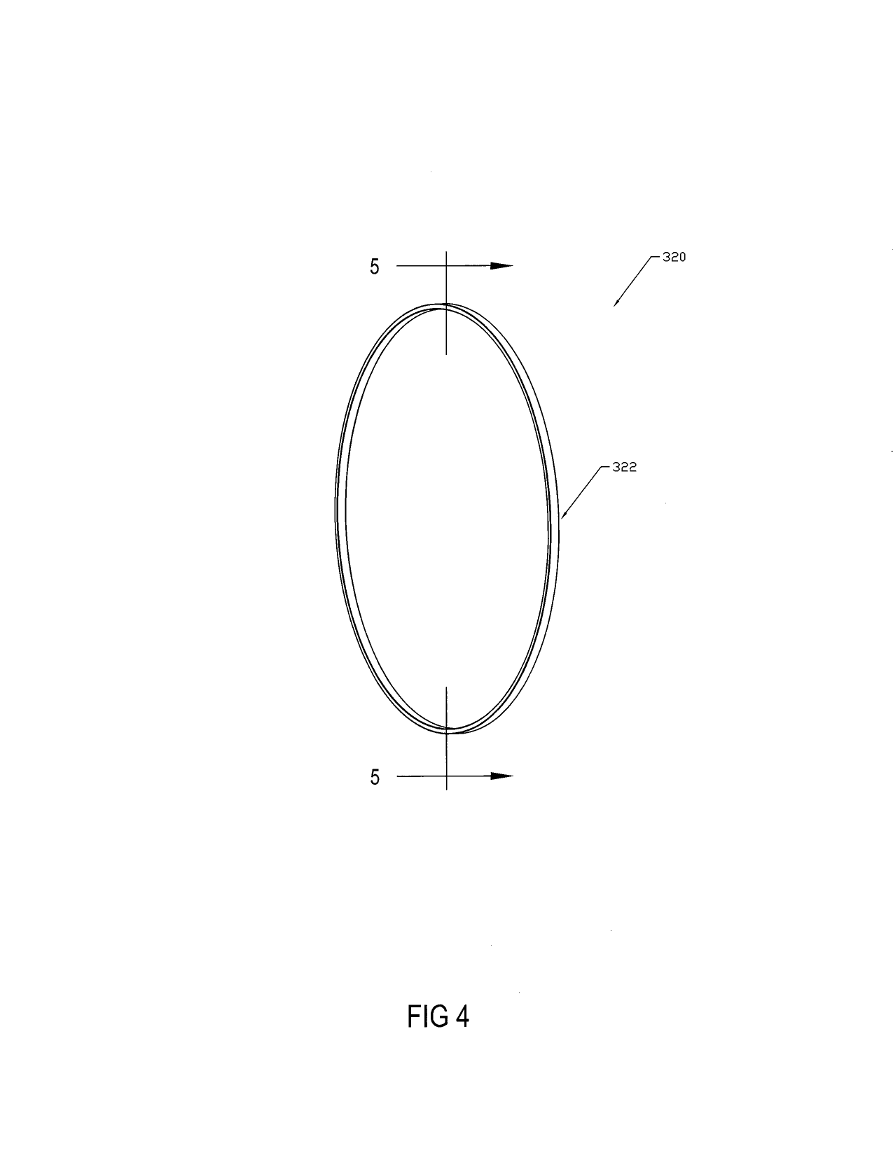

As best shown in FIGS. 4 and 5, the circular support ring 322 has a rectangular cross-section. This helps facilitate convenient and simple attachment of the plurality of wind tunnel body sector members 310a-310x thereto. Also, the rectangular cross-sectional profile of the circular support ring 322 helps to provide stability to the plurality of wind tunnel body sector members 310a-310x for resisting offsetting torque forces and the like wherein flat or planar surfaces of the plurality of wind tunnel body sector members 310a-310x engage and rest against corresponding flat or planar surfaces of the circular support ring 322. As best shown in FIG. 5, the support ring 322 defines an inner hollow region 502. This helps reduce the cost and weight of the ring 322 without satisfying performance characteristics.

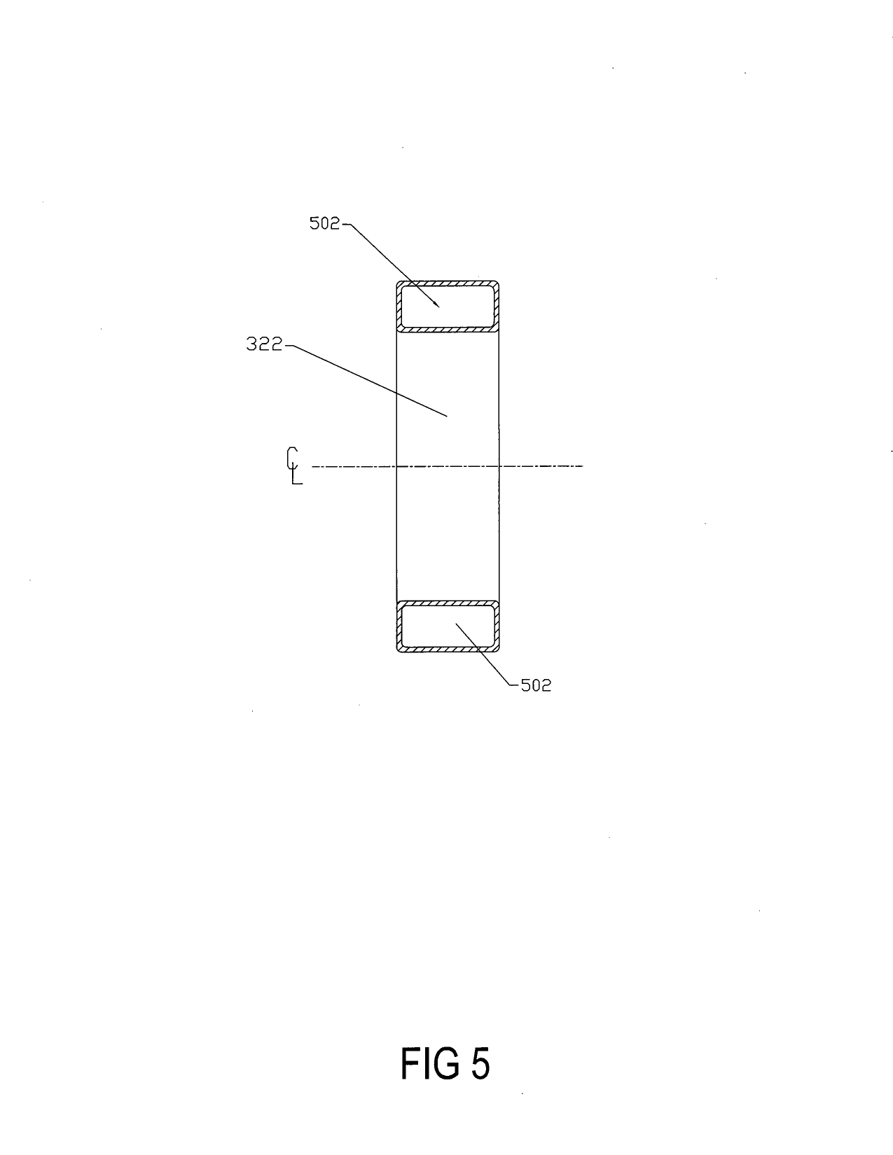

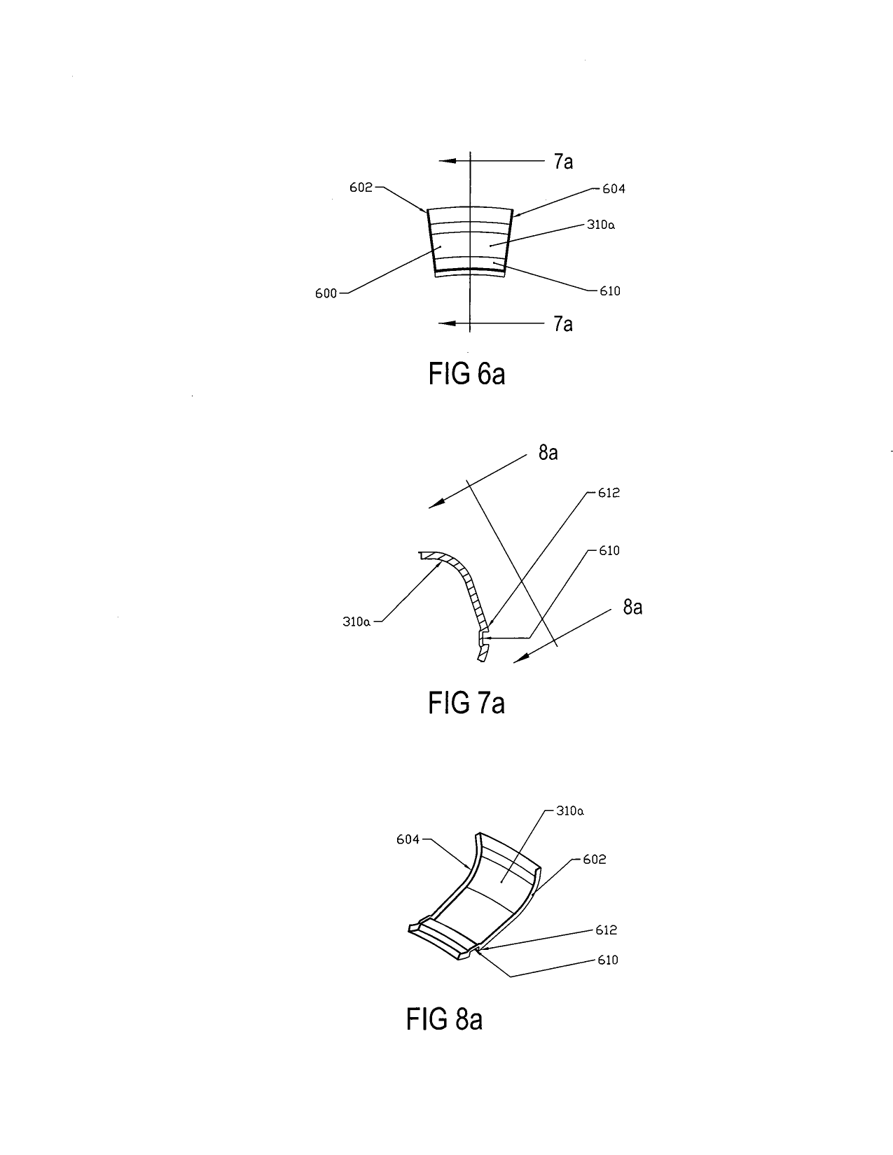

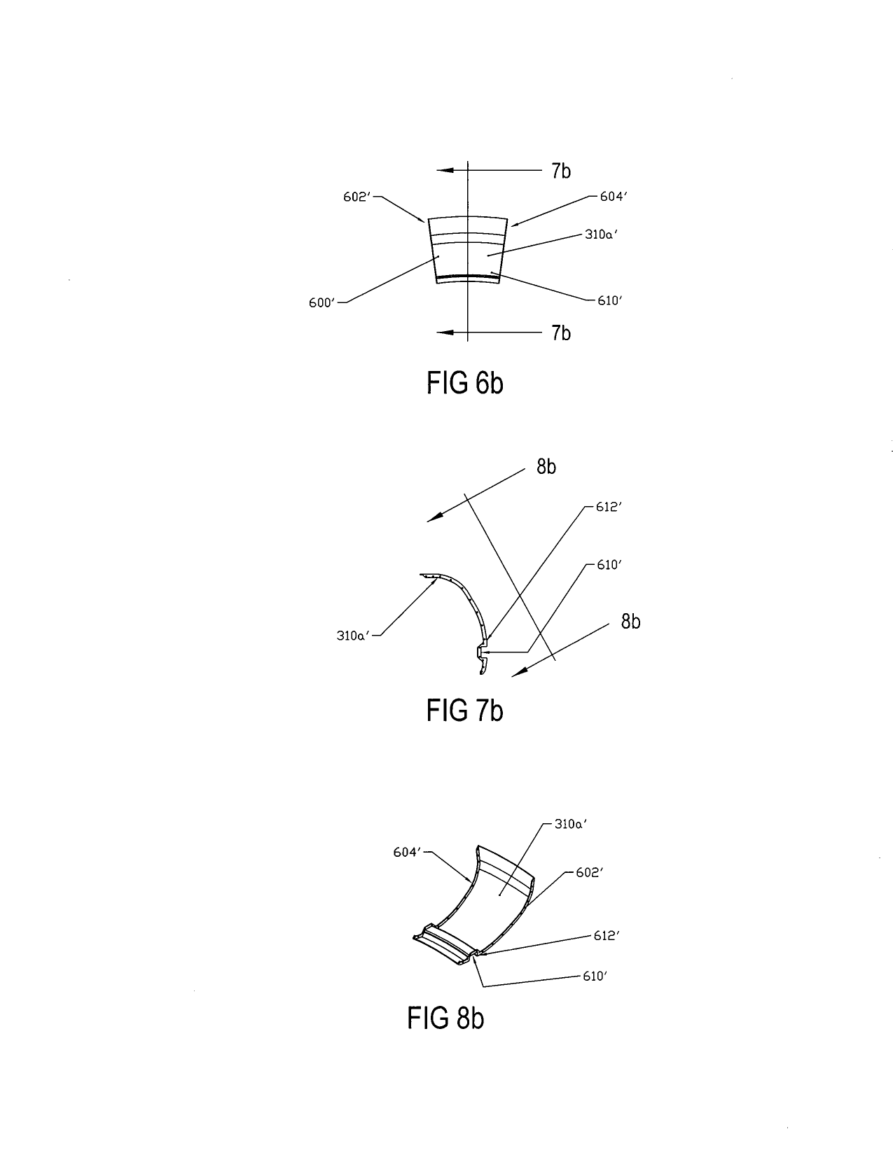

FIGS. 6a, 7a, and 8a show elevational and cross-sectional views of a representative wind tunnel body sector member 310a in accordance with a first example embodiment. Each sector member includes a sector member body portion 600, a pair of connection ribs 602, 604 on opposite sides of the body portion 600, and a support ring attachment portion 610. The pair of connection ribs 602, 604 on opposite sides of the body portion 600 conveniently enable the wind tunnel body sector members 310a-310x to be mutually coupled together in an annular ring confirmation such as shown in FIGS. 1-3. The support ring attachment portion 610 defines a recessed region having a size and shape to accommodate the circular support ring 322. During assembly, the wind tunnel body sector members are selectively placed onto the support ring member at the recessed region and fastened thereto. Each sector member is in turn fastened to the support ring member as well as to previously placed sector member. Any fastening means may be used for this purpose such as for example, bolts, screws or epoxies. Essentially, the first connection rib 602 of a first sector member positioned on the support ring member is made to align with the second connection rib 604 of an adjacent sector member similarly positioned on the support ring member and in abutting contact with the first sector member, and then fastened together at the contacting connection ribs. This step or process is repeated around the circle of the ring 322 until the wind tunnel body 250 is completed.

FIGS. 6b, 7b, and 8b show elevational and cross-sectional views of a representative wind tunnel body sector member 310a′ in accordance with a second example embodiment. Each sector member includes a sector member body portion 600′, a pair of connection ribs 602′, 604′ on opposite sides of the body portion 600′, and a support ring attachment portion 610′. The pair of connection ribs 602′, 604′ on opposite sides of the body portion 600′ conveniently enable the wind tunnel body sector members 310a′-310x′ to be mutually coupled together in an annular ring confirmation such as shown in FIGS. 1-3. During assembly, the support ring attachment portion 610′ defines a recessed region having a size and shape to accommodate the circular support ring 322′. The wind tunnel body sector members are selectively placed onto the support ring member at the recessed region and fastened thereto. Each sector member is in turn fastened to the support ring member as well as to previously placed sector member. Any fastening means may be used for this purpose such as for example, bolts, screws or epoxies. Essentially, the first connection rib 602′ of a first sector member positioned on the support ring member is made to align with the second connection rib 604′ of an adjacent sector member similarly positioned on the support ring member and in abutting contact with the first sector member, and then fastened together at the contacting connection ribs. This step or process is repeated around the circle of the ring 322 until the wind tunnel body 250 is completed.

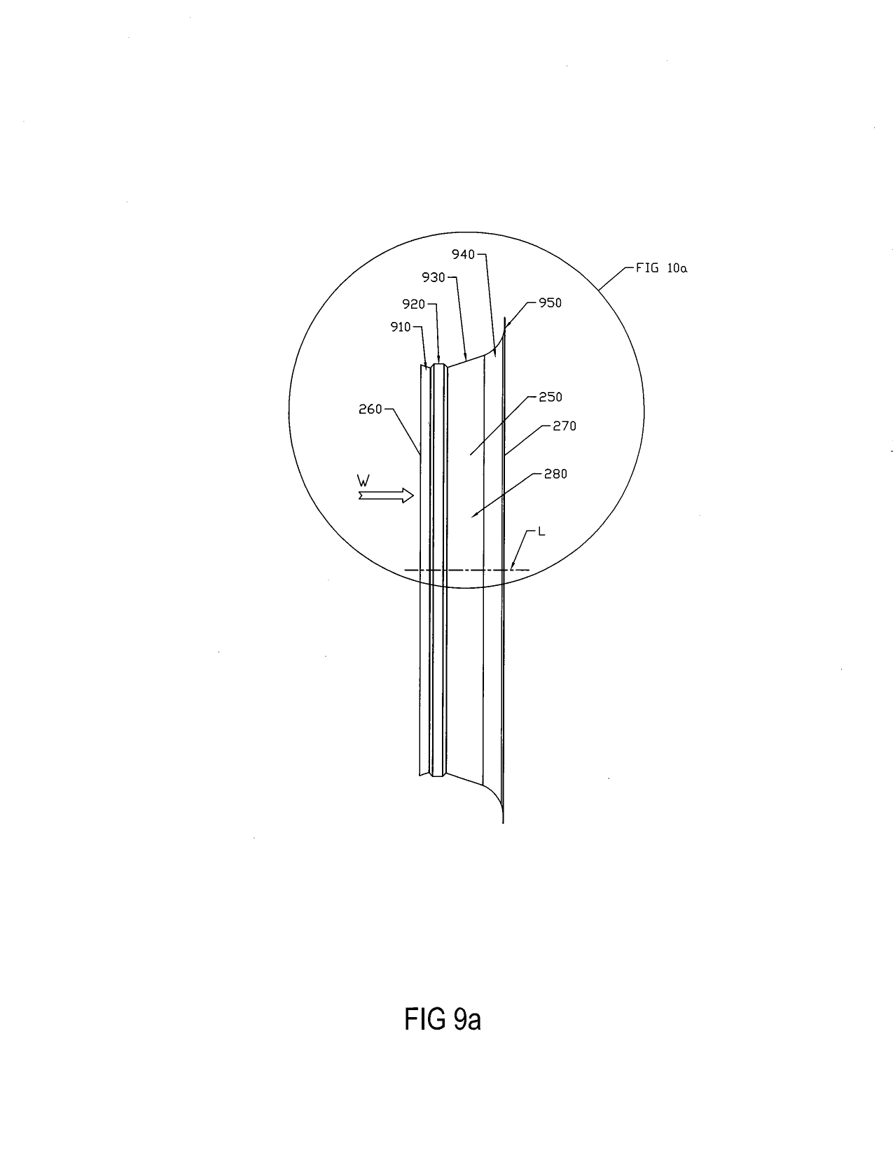

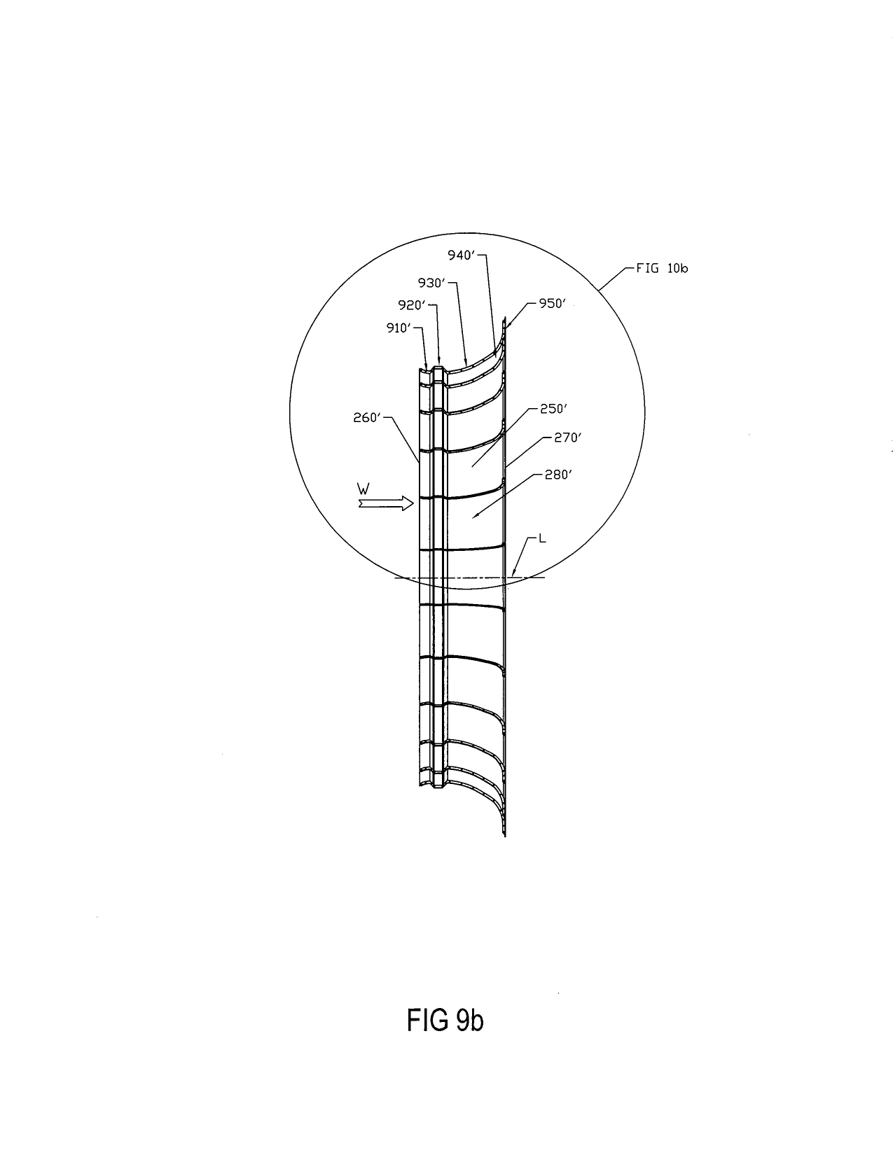

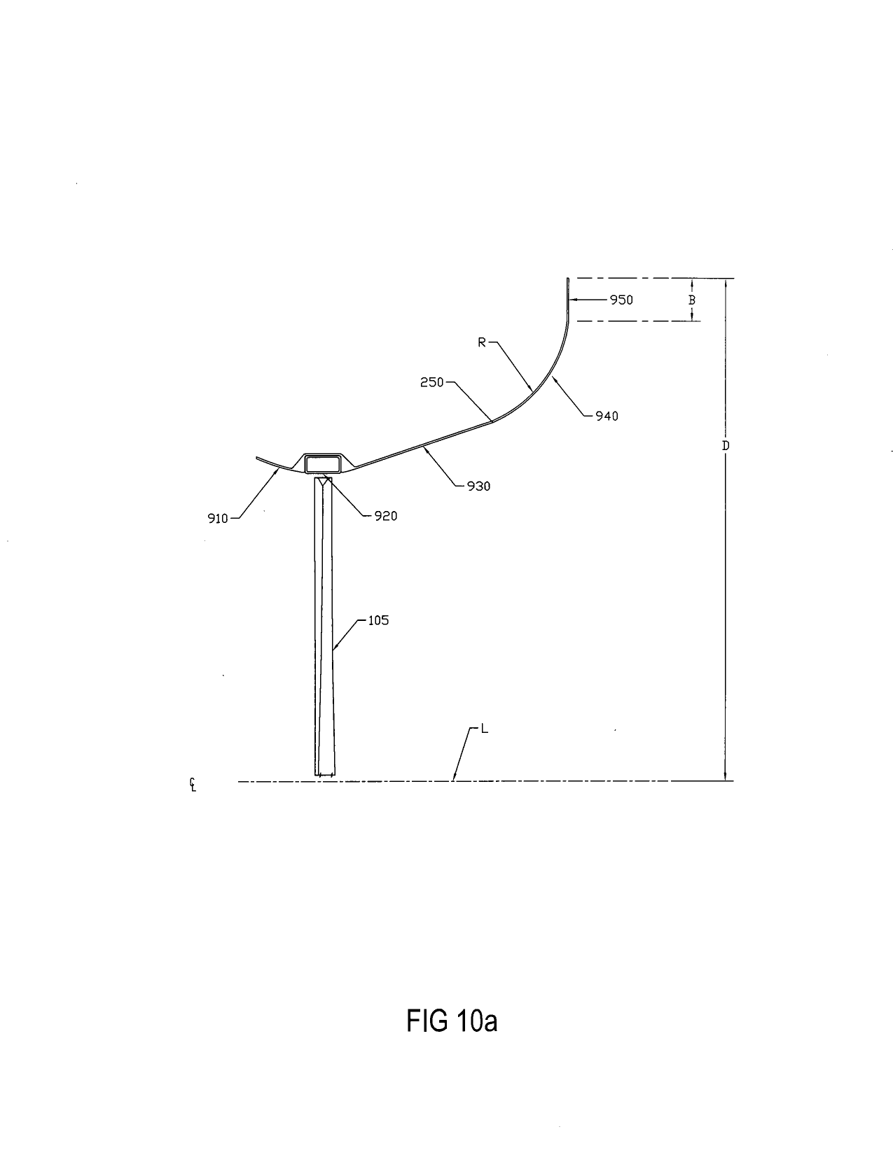

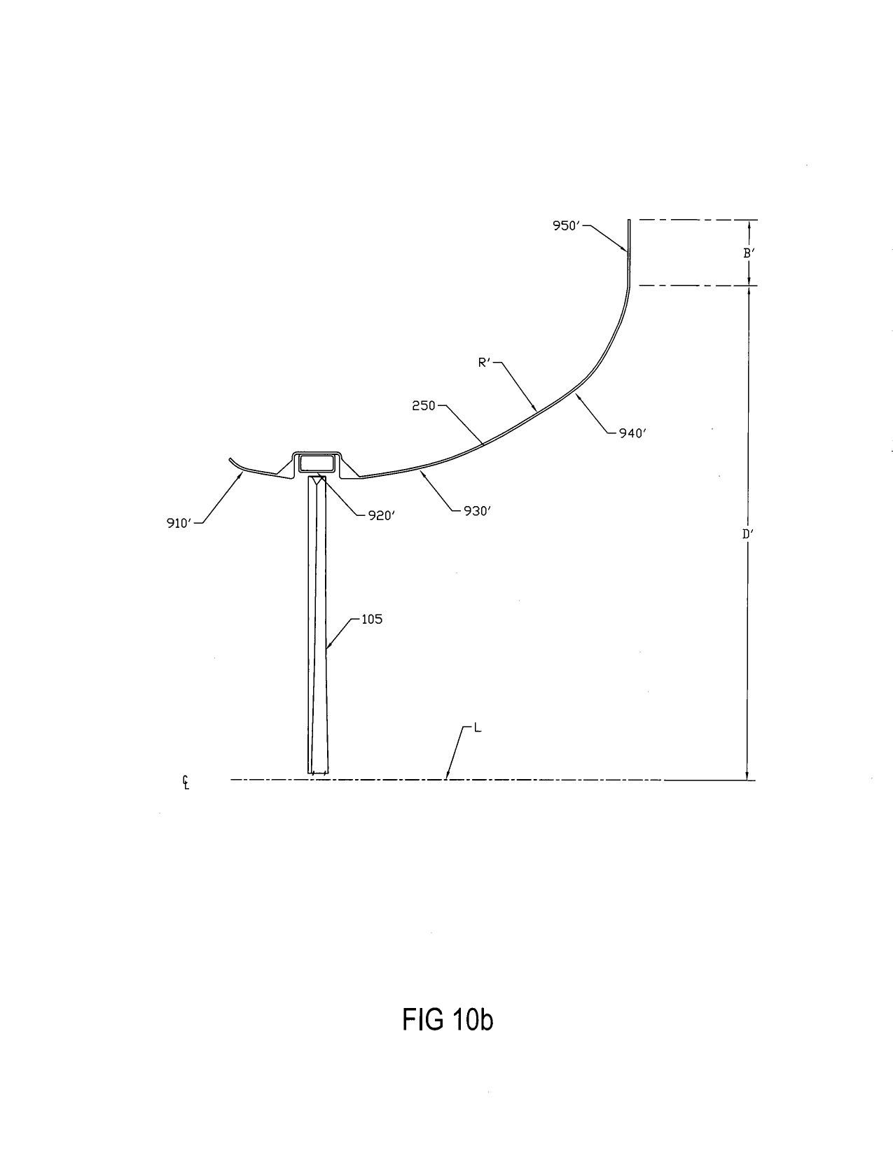

FIGS. 9a and 10a are elevational side and enlarged cross-sectional views of the wind shroud apparatus shown in FIG. 3 and formed in accordance with the first example embodiment. The shroud is illustrated without showing the connection ribs 602, 604 for ease of illustration of the contour and overall shape and proportions of the shroud 112. In the example embodiment, one preferred size of the shroud 112 without limitation to other sizes is an overall size of about 410 inches in a direction transverse to the longitudinal axis L by about 70 inches in the direction of the longitudinal axis L, wherein the inner diameter D of the main body is about 168 inches. It is to be appreciated that the dimensions described above and indicated on the drawing Figures are merely representative of an example embodiment only in that other sizes and shapes of a shroud 112 having a wind tunnel body 250 may be equivalently used as well. It is to be further appreciated that although the shroud portions are illustrated as being generally rectangular, linear, or curved in cross-section, other shapes, sizes, and orientations of the portions may equivalently be used as well.

As shown best in FIG. 9a, the wind shroud 112 comprises a cylindrical wind tunnel body 250 defining a central longitudinal axis L therethrough. The wind tunnel body 250 has an inlet 260 configured to receive a wind flow into the wind tunnel body 250, an outlet 270 configured to expel the wind flow out from the wind tunnel body 250, and a central side wall portion 280 configured to communicate the wind flow from the inlet 260 to the outlet 270 in a wind flowing direction W.

In accordance with the example embodiment, as shown in FIG. 10a, central side wall portion 280 of the cylindrical wind tunnel body 250 comprises an air horn member 910, a circular cylindrical member 920, a conical member 930, a skirt member 940, and a brim member 950. The air horn member 910 narrows in the wind flowing direction W. Also, the air horn member 910 is formed on an intake opening edge of the inlet 260 of the wind tunnel body 250. The circular cylindrical member 920 extends in parallel with the longitudinal axis L and thus has a substantially constant diameter in the wind flowing direction W and is disposed between the air horn member 910 and the outlet 270. The conical member 930 has a substantially constantly increasing diameter in the wind flowing direction W and is disposed between the circular cylindrical member 920 and the outlet 270. The skirt member 940 expands radially outwardly and is disposed between the circular conical member 930 and the outlet 270. In the example embodiment shown, the skirt member 940 defines a first radius R. The brim member 950 of the wind shroud is collar-shaped and extends radially outwardly B. In addition, the brim member 950 is formed on an outside of an exhaust opening edge of the outlet 270 of the wind tunnel body 250.

FIGS. 9b and 10b are elevational side and enlarged cross-sectional views of the wind shroud apparatus shown in FIG. 3 and formed in accordance with the second example embodiment. In the example embodiment, one preferred size of the shroud 112′ without limitation to other sizes is an overall size of about 410 inches in a direction transverse to the longitudinal axis L by about 70 inches in the direction of the longitudinal axis L, wherein the inner diameter D of the main body is about 168 inches. It is to be appreciated that the dimensions described above and indicated on the drawing Figures are merely representative of an example embodiment only in that other sizes and shapes of a shroud 112′ having a wind tunnel body 250′ may be equivalently used as well. It is to be further appreciated that although the shroud portions are illustrated as being generally rectangular, linear, or curved in cross-section, other shapes, sizes, and orientations of the portions may equivalently be used as well.

As shown best in FIG. 9b, the wind shroud 112 comprises a cylindrical wind tunnel body 250′ defining a central longitudinal axis L therethrough. The wind tunnel body 250′ has an inlet 260′ configured to receive a wind flow into the wind tunnel body 250′, an outlet 270′ configured to expel the wind flow out from the wind tunnel body 250′, and a central side wall portion 280′ configured to communicate the wind flow from the inlet 260′ to the outlet 270′ in a wind flowing direction W.

In accordance with the example embodiment, as shown in FIG. 10b, central side wall portion 280 of the cylindrical wind tunnel body 250′ comprises an air horn member 910′, a circular cylindrical member 920′, a conical member 930′, a skirt member 940′, and a brim member 950′. The air horn member 910′ narrows in the wind flowing direction W. Also, the air horn member 910′ is formed on an intake opening edge of the inlet 260′ of the wind tunnel body 250′. The circular cylindrical member 920′ extends in parallel with the longitudinal axis L and thus has a substantially constant diameter in the wind flowing direction W and is disposed between the air horn member 910′ and the outlet 270′. The conical member 930′ has a smooth inner surface smoothly expanding in the wind flowing direction W and is disposed between the circular cylindrical member 920′ and the outlet 270′. The skirt member 940′ expands radially outwardly and is disposed between the circular conical member 930′ and the outlet 270′. In the example embodiment shown, the skirt member 940′ defines a first radius R. The brim member 950′ of the wind shroud is collar-shaped and extends radially outwardly B. In addition, the brim member 950′ is formed on an outside of an exhaust opening edge of the outlet 270′ of the wind tunnel body 250′.

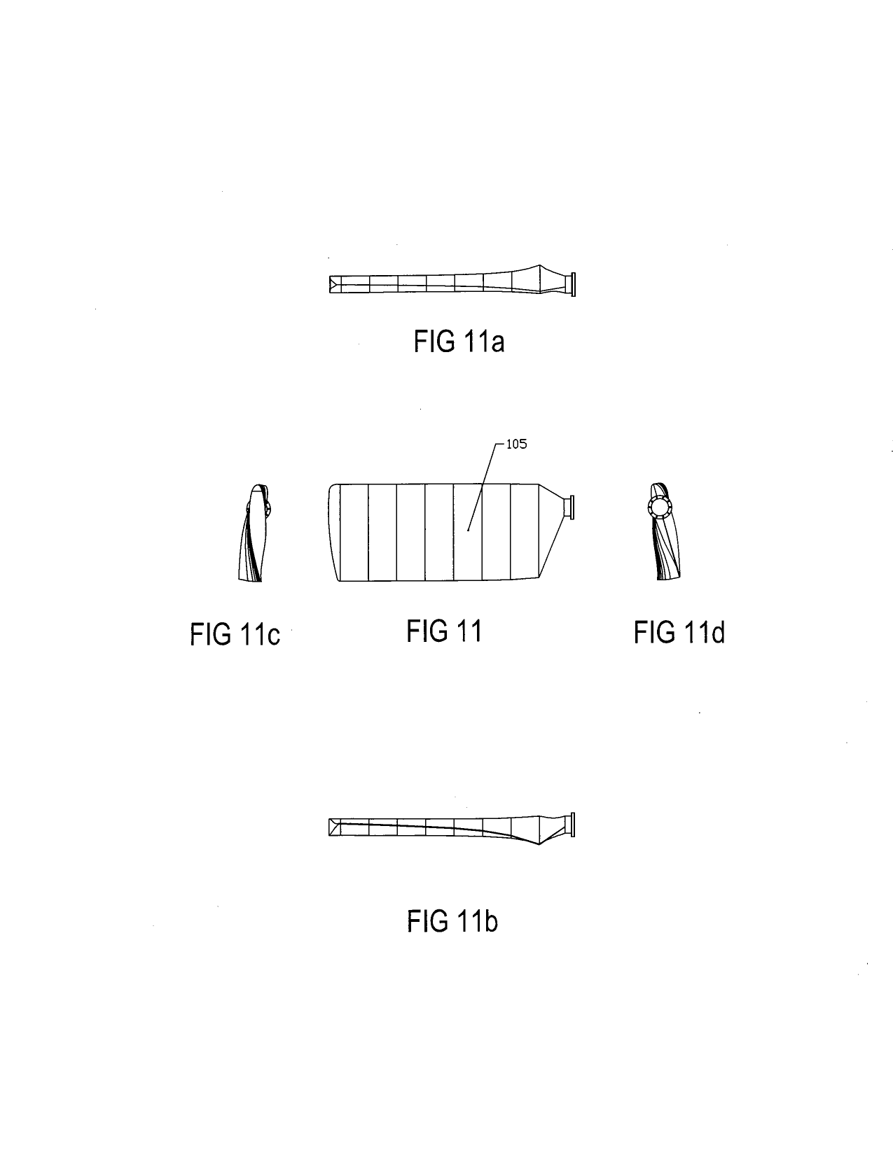

With reference next to FIGS. 11a-11d, a representative the blade member 105 of the wind tower system 100 is shown. In its preferred form, the blades are of a constant chord construction and have a MS 1-0317 foil contour.

In the embodiments, a wind turbine shroud includes means for generating a pronounced rapid high to low air pressure migration across the blades produces substantial wind power quotient increases, wherein the means comprises in combination a cylindrical wind tunnel shroud body including a radially outwardly extending collar-shaped brim member formed on an outside of an exhaust opening edge of an outlet of the wind tunnel body, and an axially extending tubular-shaped rim member formed on the exhaust opening edge of the outlet of the wind tunnel body.

In addition, it is to be appreciated that the shroud 112 herein is readily adaptable for use in place of the shroud structure described in connection with the other related wind turbine and tower apparatus disclosed in U.S. Ser. No. 11/845,094 incorporated herein by reference. The embodiments herein are not limited to those shown but include other shroud structures and the shroud used in other wind turbines.

It is now claimed:

1. A wind power generator comprising:
a cylindrical wind tunnel body defining a central longitudinal axis therethrough, the wind tunnel body having an inlet configured to receive a wind flow into the wind tunnel body, an outlet configured to expel the wind flow out from the wind tunnel body, and a central side wall portion configured to communicate the wind flow from the inlet to the outlet in a wind flowing direction; and,
a wind turbine for generating electricity, the wind turbine being arranged adjacent to the inlet of the wind tunnel body.

2. The wind power generator according to claim 1, wherein the central side wall portion of the cylindrical wind tunnel body comprises:
an air horn member narrowing in the wind flowing direction, the air horn member being formed on an intake opening edge of the inlet of the wind tunnel body;
a circular cylindrical member having a substantially constant diameter in the wind flowing direction and being disposed between the air horn member and the outlet;
a conical member having a substantially constantly increasing diameter in the wind flowing direction and being disposed between the circular cylindrical member and the outlet; and,
a skirt member expanding radially outwardly and being disposed between the circular conical member and the outlet, the skirt member defining a first radius R.

3. The wind power generator according to claim 2, further comprising:
a radially outwardly extending collar-shaped brim member formed on an outside of an exhaust opening edge of the outlet of the wind tunnel body.

4. The wind power generator according to claim 3, wherein:
the brim member extends radially outwardly front the skirt member in a direction substantially perpendicular to the central longitudinal axis.

5. The wind power generator according to claim 1, wherein the central side wall portion of the cylindrical wind tunnel body comprises:
an air horn member narrowing in the wind flowing direction, the air horn member being formed on an intake opening edge of the inlet of the wind tunnel body;
a circular cylindrical member having a substantially constant diameter in the wind flowing direction and being disposed between the air horn member and the outlet;
a conical member having a smooth inner surface smoothly expanding in the wind flowing direction and being disposed between the circular cylindrical member and the outlet; and,
a skirt member expanding radially outwardly and being disposed between the circular conical member and the outlet, the skirt member defining a first radius R.

6. The wind power generator according to claim 5, further comprising:
a radially outwardly extending collar-shaped brim member formed on an outside of an exhaust opening edge of the outlet of the wind tunnel body.

7. The wind power generator according to claim 6, wherein:
the brim member extends radially outwardly from the skirt member in a direction substantially perpendicular to the central longitudinal axis.

8. The wind power generator according to claim 1, further comprising:
a circular structural support ring, wherein the cylindrical wind tunnel body comprises a plurality of wind tunnel body sector members carried on the circular structural support ring.

9. The wind power generator according to claim 8, wherein each of the plurality of wind tunnel body sector members of the cylindrical wind tunnel body are substantially identically formed.

10. The wind power generator according to claim 1, wherein the cylindrical wind tunnel body comprises:
a circular structural support ring; and,
a plurality of substantially identically formed wind tunnel body sector members carried on the circular structural support ring, wherein each of the sector members subtends an angle of about 15 degrees.

11. The wind power generator according to claim 1, wherein the central side wall portion is formed of a carbon fiber material and is configured to communicate the wind flow from the inlet to the outlet in the wind flowing direction, wherein the wind flowing direction is substantially parallel with the central longitudinal axis.

12. The wind power generator according to claim 1, wherein the wind turbine comprises a plurality of blade members, wherein each of the plurality of blade members comprises an elongate wide constant cord body member.

13. A wind shroud for use with an associated wind power generator including a wind turbine for generating electricity, the wind shroud comprising:
a cylindrical wind tunnel body defining a central longitudinal axis therethrough, the wind tunnel body having an inlet configured to receive a wind flow into the wind tunnel body, an outlet configured to expel the wind flow out from the wind tunnel body, and a central side wall portion configured to communicate the wind flow from the inlet to the outlet in a wind flowing direction.

14. The wind shroud according to claim 13, wherein the central side wall portion of the cylindrical wind tunnel body comprises:
an air horn member narrowing in the wind flowing direction, the air horn member being formed on an intake opening edge of the inlet of the wind tunnel body;
a circular cylindrical member having a substantially constant diameter in the wind flowing direction and being disposed between the air horn member and the outlet;
a conical member having a substantially constantly increasing diameter in the wind flowing direction and being disposed between the circular cylindrical member and the outlet; and,
a skirt member expanding radially outwardly and being disposed between the circular conical member and the outlet, the skirt member defining a first radius R.

15. The wind shroud according to claim 14, further comprising:
a radially outwardly extending collar-shaped brim member formed on an outside of an exhaust opening edge of the outlet of the wind tunnel body.

16. The wind shroud according to claim 15, wherein:
the brim member extends radially outwardly from the skirt member in a direction substantially perpendicular to the central longitudinal axis.

17. The wind shroud according to claim 13, wherein the central side wall portion of the cylindrical wind tunnel body comprises:
an air horn member narrowing in the wind flowing direction, the air horn member being formed on an intake opening edge of the inlet of the wind tunnel body;
a circular cylindrical member having a substantially constant diameter in the wind flowing direction and being disposed between the air horn member and the outlet;
a conical member having a smooth inner surface smoothly expanding in the wind flowing direction and being disposed between the circular cylindrical member and the outlet; and,
a skirt member expanding radially outwardly and being disposed between the circular conical member and the outlet, the skirt member defining a first radius R.

18. The wind shroud according to claim 17, further comprising:
a radially outwardly extending collar-shaped brim member formed on an outside of an exhaust opening edge of the outlet of the wind tunnel body.

19. The wind shroud according to claim 18, wherein:
the brim member extends radially outwardly from the skirt member in a direction substantially perpendicular to the central longitudinal axis.

20. The wind shroud according to claim 13, further comprising:
a circular structural support ring, wherein the cylindrical wind tunnel body comprises a plurality of wind tunnel body sector members carried on the circular structural support ring.

21. The wind shroud according to claim 20, wherein each of the plurality of wind tunnel body sector members of the cylindrical wind tunnel body are substantially identically formed.

22. The wind shroud according to claim 13, wherein the cylindrical wind tunnel body comprises:
a circular structural support ring; and,
a plurality of substantially identically formed wind tunnel body sector members carried on the circular structural support ring, wherein each of the sector members subtends an angle of about 15 degrees.

23. The wind shroud according to claim 13, wherein the central side wall portion is formed of a carbon fiber material and is configured to communicate the wind flow from the inlet to the outlet in the wind flowing direction, wherein the wind flowing direction is substantially parallel with the central longitudinal axis.
